(19) United States
(12) Patent Application Publication
(10) Pub. No.: US 2008/0289395 A1
(43) Pub. Date: Nov. 27, 2008

(54) Testing machine

(75) Inventors: Jeng-Yan Torng, Nan-Tou Hsien (TW); Se-Xin Hsu, Changhua Hsien (TW); Kaung-Wei Chuang, Taichung Hsien (TW); Mei-Chung Kao, Nan-Tou Hsien (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: Universal Scientific Industrial Co., Ltd., Nan-Tou Hsien (TW)

(21) Appl. No.: 11/892,211

(22) Filed: Aug. 21, 2007

(30) Foreign Application Priority Data
May 23, 2007 (TW) 096208380

(51) Int. Cl. G01N 3/30

(52) U.S. Cl. 73/12.06

(57) ABSTRACT

A testing machine includes a main mechanism, an auxiliary unit, and a control unit. The auxiliary unit has at least one holding arm mounted pivotally on the main mechanism, and at least one suction member attached to the holding arm and adapted to hold releasably an object. The control unit is provided to control the suction member to change between a suctioning condition to suck the object and a non-suctioning condition to permit the object to drop from the suction member.

### BACKGROUND OF THE INVENTION

1. Field of the Invention

This invention relates to a testing machine, more particularly to a testing machine that can perform a drop test and a ball-impact test.

2. Description of the Related Art

Small electronic products, such as portable electronic products, often undergo a drop test during development and production so as to ensure that a guaranteed specification is met when a consumer uses the electronic product.

Referring to FIG. 1, a currently available testing machine 1 has a main mechanism 11 and a carrier 12. The main mechanism 11 includes a base 111 mounted on the ground, and a vertical post 112 connected to the base 111, and the carrier 12 slides over the vertical post 112. A holding plate 122 is connected pivotally to the carrier 12, and a control handle 123 to control movement of the holding plate 122. When it is desired to perform a drop test on a small electronic product (not shown), which is being referred to hereinafter as a test object, the carrier 12 is first adjusted to a testing height, and the control handle 123 is subsequently operated so as to move the holding plate 122 to a horizontal retaining position (not shown). The test object is then placed stably on the holding plate 122. Finally, the control handle 123 is operated again so as to release the test object from the holding plate 122, thereby allowing the test object to fall under the influence of gravity to the base 111 and thereby completing the drop test.

Although the aforementioned testing machine 1 can achieve its intended purpose, a test object must have a flat face so as to be placed stably on the holding plate 122. Further, the testing machine 1 cannot hold or retain a test object at an intended angular position. Moreover, each time the drop test is performed, only one test object can be placed on the holding plate 122. If more than one test object is placed on the holding plate 122, when the test objects are released from the holding plate 122, they will often bump into each other during their fall or upon touching the base 111, so that the resulting drop test is not accurate.

### SUMMARY OF THE INVENTION

One object of the present invention is to provide a testing machine that can effectively secure a test object, and do so at a predetermined test angle.

Another object of the present invention is to provide a testing machine that can complete drop testing of a plurality of test objects in one cycle of test operation.

Still another object of the present invention is to provide a testing machine that can perform a ball-impact test.

According to this invention, a testing machine comprises a main mechanism, an auxiliary unit, and a control unit. The auxiliary unit has at least one holding arm mounted pivotally on the main mechanism, and at least one suction member attached to the holding arm and adapted to hold releasably an object. The control unit is provided to control the suction member to change between a suctioning condition to suck the object and a non-suctioning condition to permit the object to drop from the suction member.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a currently available testing machine;

FIG. 2 is a perspective view of a testing machine according to the preferred embodiment of the present invention;

FIG. 3 is a fragmentary perspective view of the preferred embodiment, illustrating a holding plate in a horizontal retaining position;

FIG. 4 is a view similar to FIG. 3, but illustrating the holding plate in a downwardly inclined, non-retaining position;

FIG. 5 is a view similar to FIG. 3, but illustrating two suction members attached to one holding arm of the preferred embodiment; and

FIG. 6 is a view similar to FIG. 4, but illustrating the preferred embodiment performing a ball-impact test.

### DETAILED DESCRIPTION OF THE PREFERRED EMBODIMENT

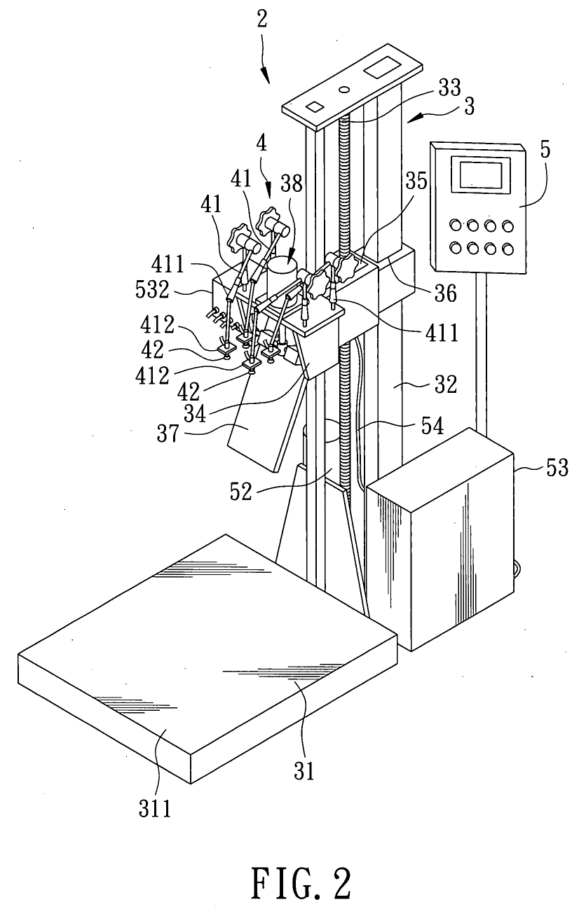

Referring to FIGS. 2 to 5, a testing machine 2 according to the preferred embodiment of the present invention may be used in drop testing a plurality of small electronic products, such as portable electronic products, and is shown to comprise a main mechanism 3, an auxiliary unit 4, and a control unit 5. The electronic products will be referred to as test objects 8 hereinafter.

The main mechanism 3 includes a base 31 mounted on the ground and having an impact face 311, a vertical post 32 connected to the base 31, a carrier 34 mounted slidably on the vertical post 32, a holding plate 37 connected pivotally to the carrier 34, a vertically extending threaded rod 33 spaced apart from the vertical post 32, and an actuator 38 mounted on the carrier 34. The carrier 34 includes a slide hole 36 for extension of the vertical post 32 therethrough, and a threaded hole 35 for extension of and for engagement with the threaded rod 33.

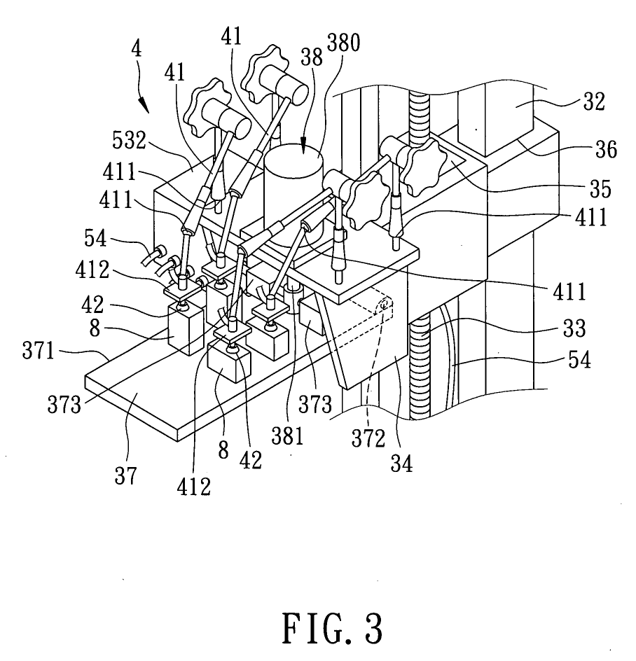

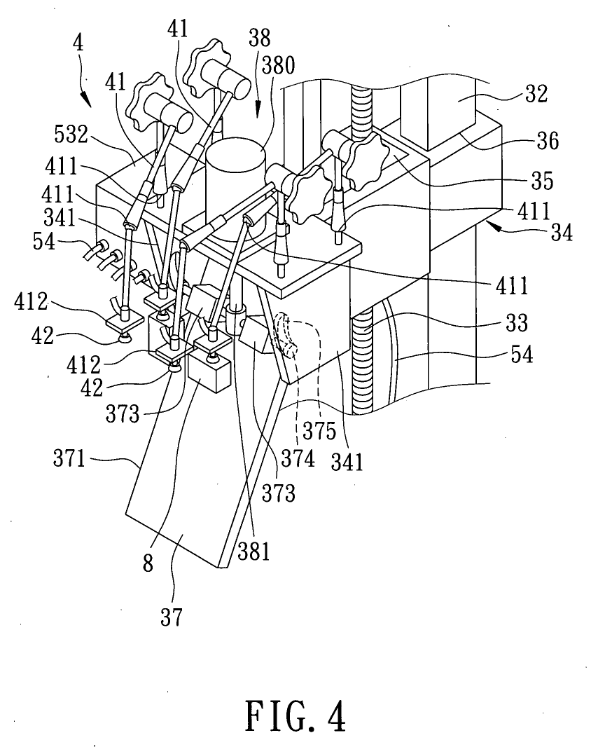

In this embodiment, the actuator 38 has a hydraulic cylinder 380 that is connected to and controlled by the control unit 5 and that can move the holding plate 37 between a horizontal retaining position, as shown in FIG. 3, where each test object 8 is supported on a support face 371 of the holding plate 37, and a downwardly inclined, non-retaining position, as shown in FIGS. 2 and 4, where the holding plate 37 permits each test object 8 to drop from the holding plate 37.

As best shown in FIG. 4, the holding plate 37 has a support face 371, a pivot shaft 372 (see FIG. 3) provided on one end of the holding plate 37 and connected pivotally to the carrier 34, driven blocks 373 disposed adjacent to the holding plate 37 and driven by the actuator 38, and a transverse rod 374 extending through the driven blocks 373. The transverse rod 374 has two ends respectively and slidably received in two arc-shaped slide grooves 375 formed respectively in two bracket plates 341 of the carrier 34. The hydraulic cylinder 380 has a piston rod 381 connected to the transverse rod 374. When the piston rod 381 moves the transverse rod 374, the holding plate 37 rotates around the shaft 372.

A motor 52 is connected electrically to the control unit 5 and the threaded rod 33, and is controlled by the control unit 5 to rotate the threaded rod 33, so that the carrier 34 is moved upwardly or downwardly through engagement of the threaded rod 33 with the threaded hole 35 in the carrier 34.

The auxiliary unit 4 includes a plurality of holding arms 41 mounted pivotally on the carrier 34, and a plurality of suction members 42 attached to the holding arms 41 and adapted to hold releasably and respectively the test objects 8. Each holding arm 41 has two universal joints 411, and a retaining element 412 connected to one suction member 42.

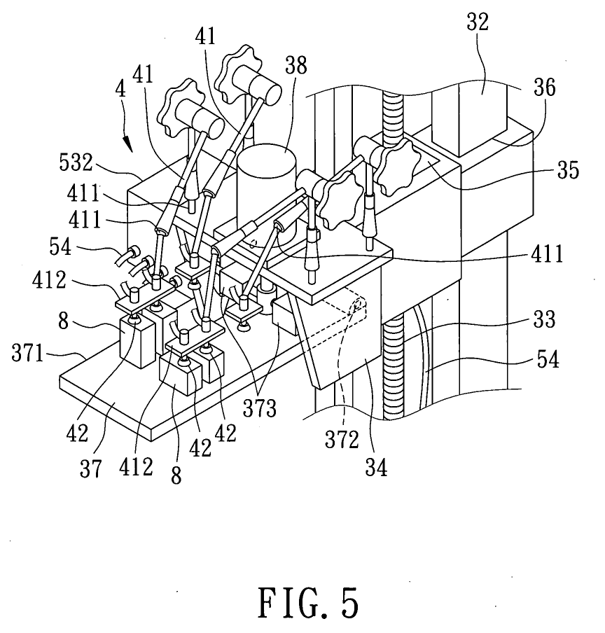

In this embodiment, the retaining element 412 of each holding arm 41 is connected to one of the suction members 42 so that the one of the suction members 42 is retained on the respective holding arm 41. Alternatively, as shown in FIG. 5, two suction members 42 may be connected to the retaining element 412 of each of the holding arms 41, so that if the size of each test object 8 is small, each holding arm 41 may hold more than one test object 8 at a time. In contrast, if each test object 8 is big, or if each test object 8 is to impact the impact face 311 of the base 31 at a particular angular position, more than one suction member 42 on the same holding arm 41 or on different holding arms 41 may be used to hold each big test object 8 disposed on the holding plate 37. Further, the number of the holding arms 41 needed to perform one cycle of drop-testing depends on the number of the test objects 8 to be subjected to drop tests or on other test requirements. The number of the holding arms 41 may vary from one to five.

It should be noted that the suction members 42 are disposed above the holding plate 37. As such, when each test object 8 is placed on the holding plate 37, the test object 8 can be positioned temporarily on the holding plate 37 through the suction member 42. While the suction members 42 are sucking discs in this embodiment, they may be vacuum chucks or the like in other embodiments.

The auxiliary unit 4 further includes a vacuum generator 53 connected electrically to and controlled by the control unit 5, and a plurality of vacuum tubes 54 each connected to the vacuum generator 53 and to the respective suction member 42. The vacuum generator 53 has a vacuum manifold having a set of operating valves 532 controlled by the control unit 5 so as to change the suction members 42 between a suctioning condition to suck the respective test objects 8 and a non-suctioning condition to permit the test objects 8 to drop from the respective suction members 42. The impact face 311 of the base 31 is located below the holding plate 37 and the suction members 42, and is adapted to be impacted by the test objects 8 dropping from the suction members 42.

Hence, the control unit 5 controls the operations of the motor 52, the vacuum generator 53, and the actuator 38. In more detail, the control unit 5 firstly controls the motor 52 so as to rotate the threaded rod 33, and thereby adjust the height of the carrier 34. However, this is an optional operation that may be omitted when the height of the carrier 34 is already at the desired level. Secondly, the control unit 5 controls the vacuum generator 53 so that the suction members 42 selectively produce suction forces through the respective vacuum tubes 54. Thirdly, the control unit 5 controls the actuator 38 so that the holding plate 37 moves between the horizontal retaining position shown in FIG. 3 and the downwardly inclined non-retaining position shown in FIGS. 2 and 4.

Below is a description of the steps involved in performing the drop test of the test objects 8 with reference to FIGS. 3 and 4.

The first step is to adjust the universal joints 411 of one holding arm 41 so as to move the suction member 42 toward one test object 8. The test object 8 is moved close to the suction member 42 at a predetermined test angle. The vacuum generator 53 is then activated through the control unit 5, so that the suction member 42 sucks the test object 8. Afterwards, the universal joints 411 of the holding arm 41 are again adjusted so as to bring the test object 8 to the desired testing height. Following the aforementioned steps, the other test objects 8 are sucked at a predetermined test angle by the respective suction members 42 of the holding arms 41. As shown in FIG. 3, there are four test objects 8, two of which are mounted horizontally, and the other two are mounted vertically. The holding plate 37 may be used to assist in adjusting the testing height of the test objects 8. For example, prior to adjusting the universal joints 411 of the holding arms 41, the holding plate 37 may first be moved to the horizontal retaining position (see FIG. 3) by operating the control unit 5, which in turn, activates the actuator 38, so that the test objects 8 can be placed on the support face 371 of the holding plate 37. The motor 52 is also activated by the control unit 5 so as to rotate the threaded rod 33, so that the threaded rod 33 moves the carrier 34 upwardly or downwardly to a testing height. Finally, the universal joints 411 of the holding arms 41 are adjusted, so that the suction members 42 of the holding arms 41 can move towards and suck securely the test objects 8, respectively.

The second step is to remove successively the suction forces of the suction members 42 through the control unit 5, so that the test objects 8 can fall successively to the impact face 311 of the base 31 by gravity, thereby completing one cycle of drop test operation. If the holding plate 37 is used to assist in adjusting the testing height of the test objects 8, then the actuator 38 must first be activated through the control unit 5 so as to move the holding plate 37 to the downwardly inclined, non-retaining position and away from the test objects 8. The suction forces of the suction members 42 are then removed through the control unit 5 so as to allow the test objects to fall by gravity to the impact face 311 of the base 31. It should be noted that after dropping of each test object 8, the next test object 8 should be dropped only after the previous test object 8 has been removed from the base 31. As such, the test objects 8 are prevented from bumping into each other in midway of their fall or on the base 31.

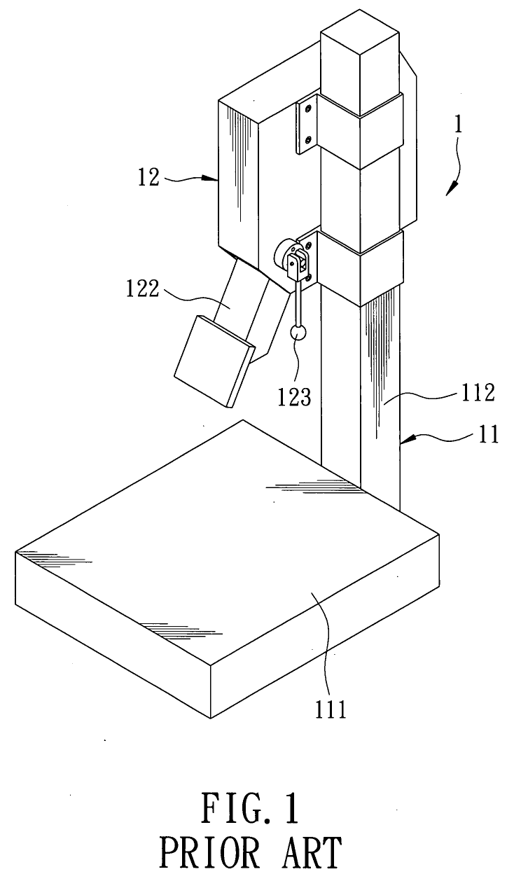

Moreover, the testing machine 2 of the present invention can also perform a test operation similar to the manner performed by the conventional testing machine 1 (see FIG. 1). For example, if a test object 8 placed on the holding plate 37 can balance itself on the holding plate 37, and if it is desired to test one test object 8 at a time, there is no need to use one of the holding arms 41 and the corresponding suction member 42 to position the test object 8 on the holding plate 37. In this case, only the actuator 38 may be activated through the control unit 5 so as to move the holding plate 37 to the downwardly inclined, non-retaining position to permit the test object 8 to fall onto the impact face 311 of the base 31.

The technical effects and advantages of the testing machine 2 of the present invention can be summarized as follows:

1. By operating the universal joints 411 to adjust the holding arms 41, the suction members 42 can retain the test objects 8 at an intended angular position regardless of whether or not the test objects 8 can be positioned stably on the holding plate 37.

2. Through the use of the holding arms 41 and the suction members 42, more than one test object 8 can be sucked. Through the control of the control unit 5, the test objects 8 can undergo testing serially. Hence, in one cycle of drop test operation, many test objects 8 can be tested.

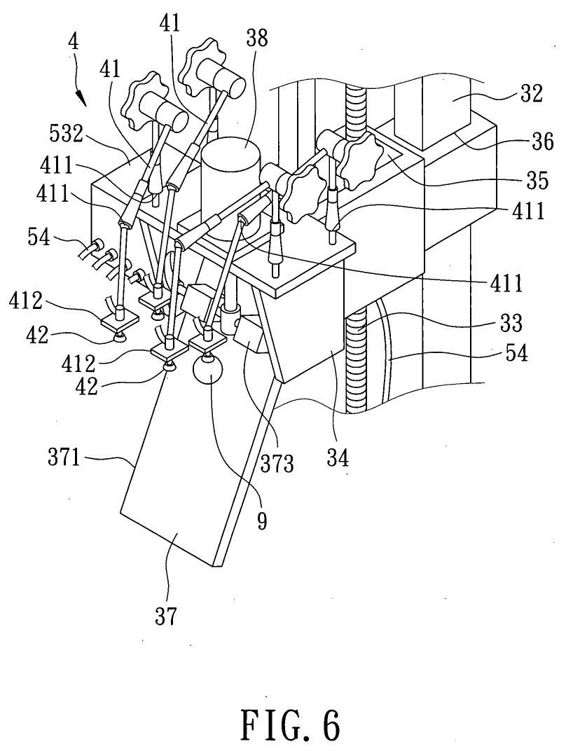

Referring additionally to FIG. 6, the testing machine 2 of the present invention can also perform a ball-impact test. When the carrier 34 is at a desired testing height, the control unit 5 is operated so as to activate the actuator 38, which is turn, moves the holding plate 37 to the downwardly inclined non-retaining position. Afterwards, the control unit 5 activates the vacuum generator 53 so that one of the suction members 42 produces a suction force to suck and hold a test ball 9 which is made of a standard weight and material. Subsequently, a test object (not shown) is placed on the impact face 311 of the base 31, and is adjusted so that the test object is right below the test ball 9, after which the control unit 5 is operated so as to remove the suction force from the suction member 42, thereby permitting the test ball 9 to fall by gravity and strike the test object positioned on the base 31. Hence, a ball-impact test operation is completed.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A testing machine, comprising:
a main mechanism;
an auxiliary unit having at least one holding arm mounted pivotally on said main mechanism, and at least one suction member attached to said holding arm and adapted to hold releasably an object; and
a control unit to control said suction member to change between a suctioning condition to suck the object and a non-suctioning condition to permit the object to drop from said suction member.

2. The testing machine of claim 1, wherein said main mechanism includes a carrier, a holding plate connected pivotally to said carrier, and an actuator to move said holding plate between a horizontal retaining position and a downwardly inclined non-retaining position.

3. The testing machine of claim 2, wherein said suction member is disposed above said holding plate.

4. The testing machine of claim 1, wherein a plurality of said suction members are attached to said holding arm.

5. The testing machine of claim 1, wherein said holding arm has at least one universal joint.

6. The testing machine of claim 1, wherein said auxiliary unit further includes a vacuum generator connected to and controlled by said control unit, and a vacuum tube to connect said vacuum generator to said suction member.

7. The testing machine of claim 1, wherein said suction member is a sucking disc.

8. The testing machine of claim 2, wherein said carrier includes a slide hole, said main mechanism further including a vertical post extending through said slide hole, said carrier being slidable along said vertical post.

9. The testing machine of claim 8, wherein said main mechanism further includes a vertically extending threaded rod, said carrier further including a threaded hole, said threaded rod extending threadedly through said threaded hole for moving said carrier upwardly or downwardly.

10. The testing machine of claim 9, further comprising a motor connected to and controlled by said control unit to rotate said threaded rod.

11. The testing machine of claim 2, wherein said actuator is a hydraulic cylinder that is connected to and controlled by said control unit.

12. The testing machine of claim 1, wherein said main mechanism has a base, a vertical post connected to said base, and a carrier mounted movably on said vertical post, said suction member being mounted on said carrier.

13. The testing machine of claim 12, wherein said main mechanism further includes a holding plate connected pivotally to said carrier and extending below said suction member, and an actuator to move said holding plate between a horizontal retaining position and a downwardly inclined non-retaining position.

14. The testing machine of claim 13, wherein said actuator is a hydraulic cylinder that is connected to and controlled by said control unit.

15. The testing machine of claim 14, wherein said auxiliary unit further includes a vacuum generator connected to and controlled by said control unit, and a vacuum tube to connect said vacuum generator to said suction member.

16. The testing machine of claim 15, further comprising a motor connected electrically to said control unit, said main mechanism further including a vertically extending threaded rod extending through and engaging said carrier and rotated by said motor to move said carrier upwardly or downwardly.
